(19) United States
(12) Patent Application Publication
(10) Pub. No.: US 2006/0067557 A1
(43) Pub. Date: Mar. 30, 2006

(54) Electronic apparatus

(75) Inventor: Akira Imamura, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/237,875

(22) Filed: Sep. 29, 2005

(30) Foreign Application Priority Data
Sep. 30, 2004 (JP) 2004-289013

(51) Int. Cl. H04R 1/02

(52) U.S. Cl. 381/388; 381/333

(57) ABSTRACT

An electronic apparatus includes: a housing including first and second covers, the first cover having a sound-radiating opening and a rib formed in a perimeter shape and disposed on an inner surface of the first cover to surround the opening, the second cover being disposed opposite to the first cover and having a support portion protruding toward the first cover; and a speaker unit disposed in the housing, the speaker including a cone and a frame that supports a circumferential portion of the cone. The frame of the speaker unit is supported on the support portion of the second cover and held between the rib of the first cover and the support portion. The frame, the cone, the first cover and the rib define a first chamber that communicates with the opening of the first cover.

### CROSS-REFERENCE TO RELATED APPLICATIONS

This application is based upon and claims the benefit of priority from the prior Japanese Patent Application No. 2004-289013, filed on Sep. 30, 2004; the entire contents of which are incorporated herein by reference.

### BACKGROUND

1. Field

The present invention relates to an electronic apparatus such as a personal computer or a portable terminal. Particularly, it relates to an electronic apparatus having a built-in sound-reproducing speaker.

2. Description of the Related Art

A portable electronic apparatus represented by a notebook type portable computer or a mobile communication apparatus has a housing, and a sound-reproducing speaker built into the housing. The opportunity of using a portable electronic apparatus for reproducing music or viewing images such as movies has increased in recent years with the advancement of CD drives, DVD drives, etc. Following this tendency, there is an increasing demand for high-performance built-in speaker units excellent in sound quality.

Generally, a speaker includes a speaker unit, and a speaker box, i.e., an enclosure in which the speaker unit is enclosed. The speaker unit together with the enclosure is disposed and fixed in the housing of the electronic apparatus. As an alternative method, there has been proposed a mounting method in which a speaker is incorporated in an electronic apparatus by screwing a speaker unit directly to an inner surface of a housing without use of any enclosure (e.g., JP-A-2000-112568).

### BRIEF SUMMARY

When the speaker unit is enclosed in the enclosure as described above, a large space is required for installing the speaker in the housing of the electronic apparatus because the speaker per se is likely to have a large size. For this reason, such a speaker is not suitable for a small-size electronic apparatus, etc. In addition, the cost of the speaker per se also becomes high.

In the mounting structure in which the speaker unit is screwed to the housing directly, connection and arrangement of wiring, etc., of the speaker become troublesome when assembling the electronic apparatus. At the same time, the screwing work is laborious and not preferable in terms of assembling efficiency. Generally, a sound-releasing opening needs to be provided in the housing. When the speaker unit comes into close contact with the inner surface of the housing and fixed thereto, the sound-releasing opening needs be substantially formed into the same shape as that of a cone of the speaker unit and needs be located in a position completely opposite to the cone. For this reason, there is a limitation in the design, the position of the sound-releasing opening, etc.

The invention is achieved under such circumstances. An object of the invention is to provide an electronic apparatus in which sound of excellent quality can be reproduced while both reduction in size and improvement in assembling efficiency can be attained.

### BRIEF DESCRIPTION OF THE DRAWINGS

FIG. 1 is a perspective view showing a portable computer according to a first embodiment of the invention;

FIG. 2 is an exploded perspective view showing a housing and a speaker unit in the portable computer;

FIG. 3 is a perspective view showing an inner surface of a top cover of the housing;

FIG. 4 is a perspective view showing a base cover of the housing and the speaker unit;

FIG. 5 is a sectional view of the portable computer taken along the line V-V of FIG. 1; and

FIG. 6 is a perspective view showing a housing and a speaker unit in a portable computer according to a second embodiment of the invention.

### DETAILED DESCRIPTION

A first embodiment in which an electronic apparatus according to the invention is applied to a portable computer will be described below in detail with reference to the drawings.

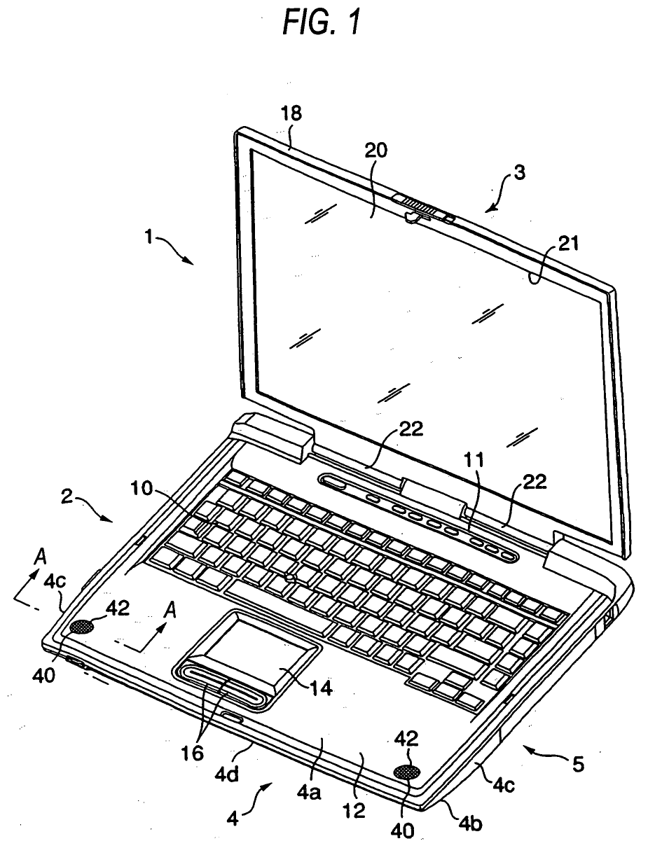

As shown in FIG. 1, a portable computer 1 includes an apparatus body 2, and a display unit 3 supported by the apparatus body 2. The apparatus body 2 has a housing 4, for example, made of synthetic resin. The housing 4 has a top cover 4a serving as a first cover, and a base cover 5 serving as a second cover. The housing 4 is shaped like a flat rectangular box. The base cover 5 has a bottom wall 4b opposite to the top cover 4a, left and right side walls 4c, a front wall 4d, and a rear wall 4e. The walls 4c to 4e are provided erectly in the circumference of the bottom wall 4b. The walls 4b to 4e are formed integrally.

In the housing 4, a keyboard 10 is provided in a center portion of the top cover 4a, and various indicators 11 are provided in a read end portion of an upper surface of the top cover 4a. A front end portion of the upper surface of the top cover 4a forms a palm rest portion 12. A touch pad 14 and click buttons 16 are provided substantially in the center of the palm rest portion 12. As will be described later, speakers are received respectively on left and right sides of the front end portion inside the housing 4.

The display unit 3 has a housing 18 shaped like a flat rectangular box, and a liquid crystal display panel 20 received in the housing. The liquid crystal display panel 20 is exposed to the outside through a display window 21 formed in the housing 18. The housing 18 has a pair of leg portions 22 protruding from one end portion of the housing 18. These leg portions 22 are supported in a rear end portion of the housing 4 by hinge portions not shown in a rotatable manner. Therefore, the display unit 3 can rotate between a close position and an open position. In the close position, the display unit 3 is laid down so as to cover the keyboard 10 from above. In the open position, the display unit 3 stands up in the rear of the keyboard 10.

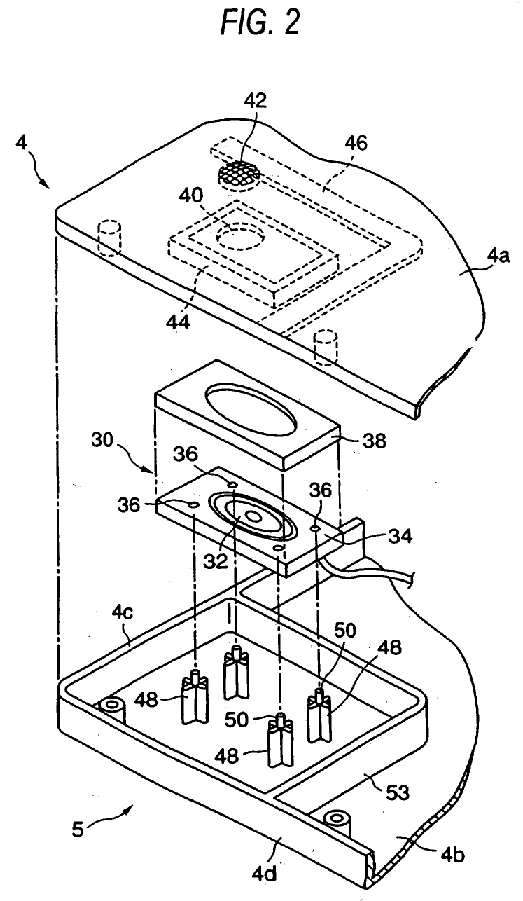

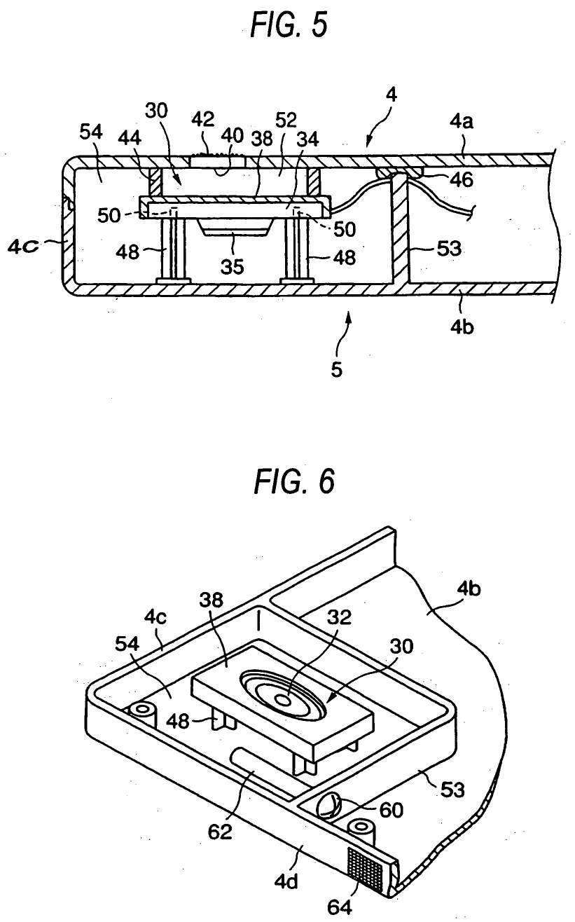

A pair of left and right speaker units 30 are mounted in the front end portion of the housing 4, and disposed separately from each other in the widthwise direction of the housing 4. One of the speaker units 30 will be described here representatively in detail. As shown in FIGS. 2, 4 and 5, for example, the speaker unit 30 has a nearly elliptic cone 32, a rectangular frame 34 supporting a circumstantial portion of the cone, and a magnet 35 supported by the frame so as to drive the cone. The parts 32, 34 and 35 are formed integrally. Through-holes 36 are formed in four corner portions of the frame 34 respectively. The speaker unit 30 has a frame-shaped elastic member 38 mounted on a circumstantial portion of the frame 34 so as to surround the cone 32. The elastic member 38 is made of a material having elasticity such as rubber.

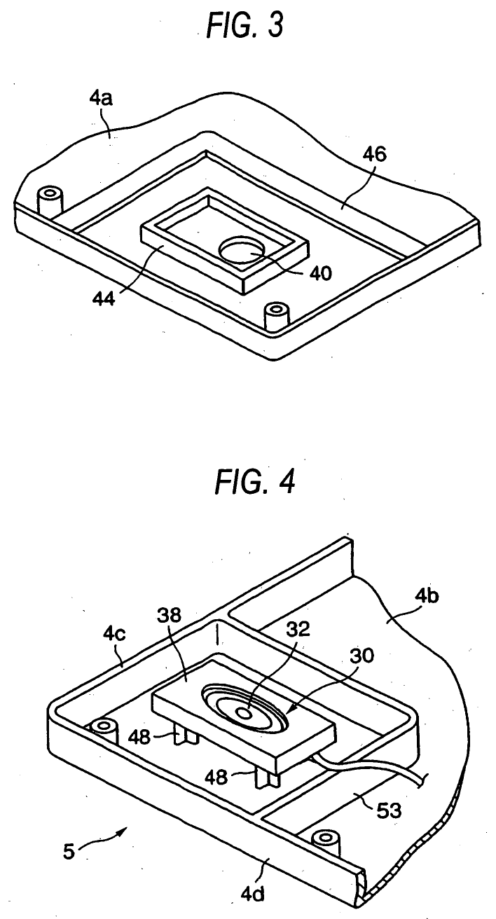

Next, description will be made on a structure for mounting the speaker units 30 in the housing 4. As shown in FIGS. 1 through 5, sound-releasing openings 40 are formed in opposite corner portions of the front end portion of the top cover 4a so as to communicate with the inside of the housing 4. For example, each of the openings 40 is shaped like a circle. Each opening 40 is covered with a mesh 42 which prevents dust penetration. Rectangular perimeter-shaped ribs 44 are provided in an inner surface of the top cover 4a so as to protrude downward from the inner surface of the top cover 4a. The ribs 44 are located to surround the openings 40 respectively. L-shaped gaskets 46, for example, made of sponge are pasted on the inner surface of the top cover 4a and located to surround the ribs 44 respectively. Each of the gaskets 46 is formed to have a predetermined width and a predetermined thickness. Incidentally, the rib may have a cylindrical shape or some other shapes.

A plurality of support posts, for example, four support posts 48 protruding toward the top cover are provided erectly in each of the opposite corner portions of the front end portion in the bottom wall 4b of the base cover 5 disposed opposite to the top cover with a gap. For example, each of the support posts has a cross-shaped transverse section. An engagement pin 50 is provided protrusively in the center portion of a tip end of each support post 48 so as to be integrated with the support post 48. The four support posts 48 are provided erectly in corner portions of a rectangle corresponding to the frame 34 of each speaker unit 30 and form a support portion for supporting the speaker unit 30.

A partition wall 53 connected to the side wall 4c and to the front wall 4d is provided erectly in the bottom wall 4b of the base cover 5 so as to be integrated with the bottom wall 4b. The partition wall 53 is substantially L-shaped and located to surround the four support posts 48. The partition wall 53 is formed to have a height substantially equal to those of the side wall 4c and the front wall 4d.

When the engagement pins 50 of the four support posts 48 are fitted into the through-holes 36 of the frame 34 in the condition that the frame 34 of each speaker unit 30 is put on the tip ends of the four support posts 48, the frame 34 of the speaker unit 30 is positioned in a predetermined position as shown in FIGS. 2, 4 and 5. In this state, the top cover 4a is put on the base cover 5. Each rib 44 of the top cover 4a abuts on the frame 34 via the elastic member 38.

In this manner, each speaker unit 30 is supported and fixed in the predetermined position in the housing 4 in the condition that the frame 34 is held between the support posts 48 and the rib 44. In addition, the frame 34 is brought into close contact with the rib 44 via the elastic member 38, so that the frame 34, the cone 32, the top cover 4a and the rib 44 define a first chamber 52 which communicates with the opening 40 of the top cover. The top (or front) and back sides of the cone 32 are separated airtightly from each other by the frame 34, the cone 32, the top cover 4a and the rib 44.

Each partition wall 53 of the base cover 5 abuts on the inner surface of the top cover 4a through the gasket 46. The bottom wall 4b, the side wall 4c, the front wall 4d and the partition wall 53 of the base cover 5 and the top cover 4a define a second chamber 54 in which the back side of the speaker unit 30 and the rib 44 are received. Sound radiated from the front surface of the cone 32 of the speaker unit 30 is released to the outside of the housing 4 through the first chamber 52 and the opening 40.

According to the portable computer configured as described above, each of the speaker units 30 disposed in the housing 4 has no independent enclosure, that is, the speaker unit is provided solely. For this reason, the space for installing the speakers in the housing 4 can be reduced, so that reduction in size and cost of the housing as a whole can be attained. Each speaker unit 30 is supported and fixed in the predetermined position in the housing 4 in the condition that the speaker unit 30 is held between the support posts 48 provided in the base cover 5 and the rib 44 provided in the top cover 4a. For this reason, it is unnecessary to use screws for mounting the speaker unit 30, so that both improvement in assembling efficiency and reduction in production cost can be attained.

The top side of each speaker unit 30 faces the first chamber 52 defined by the rib 44, the frame 34 and the top cover 4a and is separated airtightly from the back side of the speaker unit. For this reason, sound radiated from the top side of the speaker unit 30 is prevented from interfering with sound radiated from the back side of the speaker unit 30, so that sound reproduction of excellent quality can be achieved. On this occasion, because the back side of the speaker unit 30 is disposed in the second chamber 54 separated airtightly from the inside of the housing 4, it is possible to improve acoustic characteristic of the speaker unit 30.

Further, the first chamber 52 is formed on the top side of the speaker unit 30 so that sound of the speaker is released to the outside through the first chamber 52 and the opening 40 of the top cover 4a. In this case, it is not necessary to form the opening 40 into the same shape as that of the cone 32 of the speaker unit 30 and also not necessary to provide the opening in a position completely corresponding to the cone. For this reason, the shape, the forming position, etc. of the sound-releasing opening 40 can be selected arbitrarily and designed freely.

Incidentally, to mount the elastic member 38 on the frame 34 is advantageous in terms of improvement in close contact and airtightness between the frame 34 and the rib 44. If the frame and the rib can be brought into close contact with each other sufficiently, the elastic member 38 may be dispensed with.

According to the aforementioned portable computer, a good acoustic effect can be obtained because the closed first chamber 52 is provided. For this reason, the partition wall 53 of the base cover 5 for forming the second chamber 54 may be dispensed with.

When the second chamber 54 is provided, it is possible to use the second chamber 54 more effectively when a bass reflex structure is applied to the second chamber 54. That is, as shown in FIG. 6, in accordance with a portable computer according to a second embodiment of the invention, a partition wall 53 has a port 60 opened into the housing 4. An acoustic tube 62 which communicates with the port 60 is provided in a second chamber 54. A bass-radiating opening 64 which communicates with the inside of the housing 4 in the outside of the second chamber 54 is formed in the front wall 4d of the base cover 5.

The second embodiment as to the remaining configuration is the same as that of the first embodiment described above, so that parts the same as those in the first embodiment will be referred to by numerals the same as those in the first embodiment in order to omit detailed description thereof. According to the second embodiment, a bass region of sound radiated from the back side of the speaker unit 30 into the second chamber 54 is emphasized by the acoustic tube 2 and radiated from the housing 4 to the outside. Sound rich in bass can be reproduced. In addition, the same effect and operation as those of the first embodiment can be obtained in the second embodiment.

The invention is not limited to the aforementioned embodiments. Constituent members of the embodiments can be modified in a practical stage without departing from the gist of the invention. The constituent members disclosed in the embodiments can be combined suitably to form various inventions. For example, several constituent members may be removed from the all constituent members disclosed in the embodiments. In addition, constituent members in different embodiments may be combined suitably.

The invention can be applied not only to the portable computer but also to another electronic apparatus such a PDA (Personal Digital Assistant), a portable terminal or an electronic organizer. The number of speaker units is not limited to two but may be one or three or more.

What is claimed is:

1. An electronic apparatus comprising:
a housing including first and second covers, the first cover having a sound-radiating opening and a rib formed in a perimeter shape and disposed on an inner surface of the first cover to surround the opening, the second cover being disposed opposite to the first cover and having a support portion protruding toward the first cover; and
a speaker unit disposed in the housing, the speaker including a cone and a frame that supports a circumferential portion of the cone;
wherein the frame of the speaker unit is supported on the support portion of the second cover and held between the rib of the first cover and the support portion; and
the frame, the cone, the first cover and the rib define a first chamber that communicates with the opening of the first cover.

2. The electronic apparatus according to claim 1, wherein the speaker unit comprises an elastic member mounted on the frame; and
the elastic member is brought into close contact with the rib of the first cover.

3. The electronic apparatus according to claim 1, wherein the support portion comprises a plurality of support posts disposed on an inner surface of the second cover; and
tip ends of the support posts are engaged with the frame of the speaker unit.

4. The electronic apparatus according to claim 1, wherein the second cover comprises a partition wall that surrounds the speaker unit and abuts on the first cover to thereby define a second chamber.

5. The electronic apparatus according to claim 4, wherein the partition wall has a port opened into the housing; and
the electronic apparatus further comprises an acoustic tube disposed in the second chamber so as to communicate with the port.
